(19) United States
(12) Patent Application Publication
(10) Pub. No.: US 2008/0053493 A1
(43) Pub. Date: Mar. 6, 2008

(54) SUBSTRATE PROCESSING APPARATUS

(76) Inventor: Masahiro Kimura, Kyoto-shi (JP)

Correspondence Address: OSTROLENK FABER GERB & SOFFEN, 1180 AVENUE OF THE AMERICAS, NEW YORK, NY, 100368403, US

(21) Appl. No.: 11/850,265

(22) Filed: Sep. 5, 2007

(30) Foreign Application Priority Data
Sep. 5, 2006 (JP) 2006-239677

(51) Int. Cl. B08B 3/04

(52) U.S. Cl. 134/104.4

(57) ABSTRACT

A processing liquid stored in a recovery tank is stored in a purification tank after passing through an impurity removal filter and an ion component removal filter via a pipe by a suction operation of the pump. In the impurity removal filter, impurities (e.g., water, an etching residue, particles, or the like) included in the processing liquid are removed. In the ion component removal filter, an ion component (mainly anions) in the processing liquid including an acid liquid, HFEs, and a hydrophilic organic solvent is removed. In a case where hydrofluoric acid (HF) is used as the acid liquid, fluorine ions (F⁻) are removed by the ion component removal filter. The ion component removal filter also removes water, a hydrophilic organic solvent, metal ions, or the like included in the processing liquid.

### BACKGROUND OF THE INVENTION

1. Field of the Invention

The present invention relates to a substrate processing apparatus that subjects a substrate to processing.

2. Description of the Background Art

Conventionally, in processes of manufacturing semiconductor devices and liquid crystal displays, various types of chemical liquids are used for etching oxide films and others formed on substrates, cleaning surfaces of the substrates and removing polymer residues on the substrates in substrate processing apparatuses.

In the above-mentioned substrate processing apparatuses, a chemical liquid is supplied to the surface of a substrate held by a spin chuck so that the substrate is subjected to the above-mentioned processing.

Furthermore, in such substrate processing apparatuses, a processing cup is provided so as to surround the substrate held by the spin chuck. The chemical liquid separated from the substrate rotated by the spin chuck is collected by the processing cup and is fed to a gas-liquid separating device through a pipe (see JP 09-064009 A, for example).

In the gas-liquid separating device, the chemical liquid that has been used is separated into a gas component and a liquid component. The gas component obtained by the gas-liquid separating device is discharged outward, and the liquid component is discarded.

The chemical liquid used for the above-mentioned processing on substrates is generally high in cost. When the used amount of the chemical liquid is increased, therefore, processing costs (running costs) are significant. On the other hand, the chemical liquid that has been used is difficult to reuse because of changes in concentration, components, and so on.

### SUMMARY OF THE INVENTION

An object of the present invention is to provide a substrate processing apparatus capable of reducing processing costs.

(1) According to an aspect of the present invention, a substrate processing apparatus for processing a substrate includes a supplier that supplies to the substrate a processing liquid including a fluorine-based organic solvent and an acid liquid; a recovery system that recovers the processing liquid supplied to the substrate by the supplier, an ion remover that removes anions of the acid liquid in the processing liquid recovered by the recovery system, to obtain the post-removal processing liquid from which the anions have been removed, a mixer that mixes the acid liquid with the post-removal processing liquid obtained by the ion remover, to reproduce the processing liquid, and a first circulating system that returns to the supplier the processing liquid reproduced by the mixer.

In the substrate processing apparatus, the supplier supplies to the substrate the processing liquid including the fluorine-based organic solvent and the acid liquid. The recovery system recovers the processing liquid supplied to the substrate. The ion remover removes the anions of the acid liquid in the recovered processing liquid, to obtain the post-removal processing liquid from which the anions have been removed. The mixer mixes the acid liquid with the obtained post-removal processing liquid, to reproduce the processing liquid. The first circulating system returns the reproduced processing liquid to the supplier.

By such a configuration, the acid liquid can be removed from the processing liquid by removing the anions of the acid liquid in the processing liquid, so that the post-removal processing liquid including the fluorine-based organic solvent can be obtained. Furthermore, a processing liquid having a desired concentration and components can be reproduced by mixing the acid liquid with the post-removal processing liquid. In such a way, a high-cost fluorine-based organic solvent can be reused. This allows the processing cost to be reduced.

(2) The fluorine-based organic solvent may include at least one type of hydrofluoroethers, hydrofluorocarbons, and per-fluoroalkylhaloeters.

In this case, the various types of fluorine-based organic solvents, as described above, and the acid liquid are included in the processing liquid, which allows the precision of the processing of the substrate by the acid liquid to be improved.

(3) The ion remover may include a filter composed of alumina. In this case, the anions are adsorbed by alumina so that the anions are removed from the processing liquid. This allows the acid liquid in the processing liquid to be efficiently removed.

(4) The substrate processing apparatus may further include an impurity remover that removes impurities included in the processing liquid recovered by the recovery system.

In this case, the impurity remover removes the impurities included in the processing liquid recovered by the recovery system, which allows the purity of the fluorine-based organic solvent included in the post-removal processing liquid to be increased.

(5) The substrate processing apparatus may further include a storage that stores the post-removal processing liquid obtained by the ion remover.

In this case, the post-removal processing liquid in a required amount can be supplied from the storage when it is required for processing the substrate. This allows the processing to be quickened.

(6) The substrate processing apparatus may further include a concentration detector that detects the concentration of at least one type of components in the post-removal processing liquid stored in the storage, and the mixer may mix the acid liquid with the post-removal processing liquid on the basis of the results of the detection by the concentration detector.

In this case, the concentration detector detects the concentration of at least one type of the components in the post-removal processing liquid stored in the storage. The mixer mixes the acid liquid with the post-removal processing liquid on the basis of the results of the detection by the concentration detector. The concentration of at least one type of the components in the post-removal processing liquid is thus detected, so that the amount of the acid liquid to be mixed in the mixer can be adjusted. This allows a new processing liquid corresponding to the type of processing to be supplied to the substrate.

(7) The substrate processing apparatus may further include a second circulating system that returns the post-removal processing liquid stored in the storage to the upstream of the ion remover on the basis of the results of the detection by the concentration detector.

In this case, the second circulating system returns to the upstream of the ion remover the post-removal processing liquid stored in the storage on the basis of the results of the detection by the concentration detector. By such a configuration, even when the anions that have not been removed remains in the post-removal processing liquid, the post-removal processing liquid is returned again to the ion remover. In the ion remover, the anions are removed. Thus, the acid liquid in the post-removal processing liquid can be reliably removed, which allows the purity of the fluorine-based organic solvent included in the post-removal processing liquid to be sufficiently increased.

(8) The acid liquid may include at least one type of hydrofluoric acid, hydrochloric acid, sulfuric acid, and phosphoric acid.

The use of such an acid liquid allows processing for etching a film on a substrate, processing for cleaning a surface of the substrate, processing for removing a residue on the substrate, and so on to be efficiently performed.

(9) The processing liquid supplied to the substrate by the supplier may further include a hydrophilic organic solvent, the ion remover may further remove the hydrophilic organic solvent in the processing liquid recovered by the recovery system, and the mixer may further mix the hydrophilic organic solvent with the post-removal processing liquid obtained by the ion remover.

The hydrophilic organic solvent is thus included in the processing liquid supplied to the substrate by the supplier, which allows the fluorine-based organic solvent that is not easily dissolved in the acid liquid to be easily mixed with the processing liquid.

Furthermore, the ion remover removes the hydrophilic organic solvent in the processing liquid recovered by the recovery system, and the mixer mixes the hydrophilic organic solvent with the post-removal processing liquid obtained by the ion remover. By such a configuration, the unnecessary hydrophilic organic solvent in the processing liquid that has been used is removed, and the hydrophilic organic solvent in a required amount is mixed with the post-removal processing liquid when it is required for processing the substrate.

(10) The hydrophilic organic solvent may include at least one type of alcohols and ketones.

In this case, the hydrophilic organic solvent includes at least one type of alcohols and ketones, which allows the fluorine-based organic solvent to be easily mixed with the processing liquid.

(11) The supplier may supply the processing liquid to the substrate and then supply to the substrate the post-removal processing liquid with which the acid liquid has not been mixed by the mixer.

Thus, the supplier can supply to the substrate the fluorine-based organic solvent with which the acid liquid has not been mixed. In this case, the supplier supplies to the substrate a highly volatile fluorine-based organic solvent in rinsing processing, so that the drying properties of the substrate after the rinsing processing are improved, and the necessity of providing a pure water nozzle for supplying pure water to the substrate at the time of the rinsing processing, for example, is eliminated, which allows the space saving of the substrate processing apparatus.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a cross-sectional view showing the configuration of a substrate processing apparatus according to an embodiment;

FIG. 2 is a schematic block diagram showing the configuration of a recovery and reuse device; and

FIG. 3 is a block diagram showing the configuration of a control system in the substrate processing apparatus.

### DESCRIPTION OF THE PREFERRED EMBODIMENTS

A substrate processing apparatus according to an embodiment of the present invention will be now described with reference to the drawings.

In the following description, a substrate refers to a semiconductor wafer, a glass substrate for a liquid crystal display, a glass substrate for a PDP (Plasma Display Panel), a glass substrate for a photo mask, a glass substrate for an optical disk, and the like.

(1) Configuration of Substrate Processing Apparatus

The configuration of the substrate processing apparatus according to the present embodiment will be described while referring to the drawing.

In the substrate processing apparatus, processing for etching a film on a substrate, processing for cleaning a surface of the substrate, processing for removing a polymer residue (e.g., a resist residue) on the substrate, and so on are performed. Processing for etching an oxide film on the substrate will be described by way of example below.

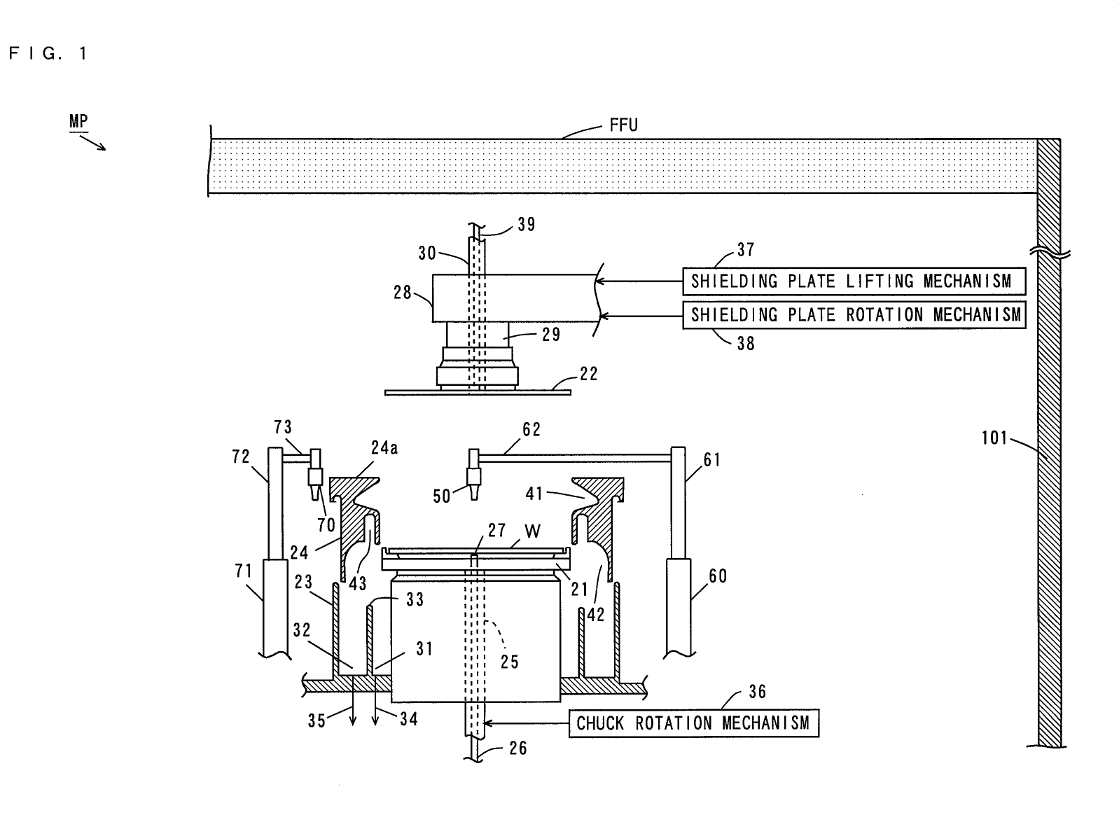

FIG. 1 is a cross-sectional view showing the configuration of a substrate processing apparatus MP according to the present embodiment.

As shown in FIG. 1, the substrate processing apparatus MP includes a housing 101, a spin chuck 21 provided inside the housing 101 and rotating around a vertical axis passing through a substantially central part of a substrate W while holding the substrate W almost horizontally, and a fan filter unit FFU provided to close an opening at an upper end of the housing 101. The fan filter unit FFU forms down flow within the housing 101. The fan filter unit FFU is composed of a fan and a filter.

The spin chuck 21 is secured to an upper end of a rotating shaft 25 that is rotated by a chuck rotation mechanism 36. The substrate W is rotated in a state where it is horizontally held by the spin chuck 21 when etching processing using a processing liquid is performed.

A first motor 60 is provided outside the spin chuck 21. A first rotating shaft 61 is connected to the first motor 60. A first arm 62 is connected to the first rotating shaft 61 so as to extend in the horizontal direction, and its tip is provided with a processing liquid nozzle 50.

The processing liquid nozzle 50 supplies a processing liquid for etching an oxide film formed on the substrate W onto the substrate W. The details of the processing liquid supplied onto the substrate W by the processing liquid nozzle 50 will be described later.

A second motor 71 is provided outside the spin chuck 21. A second rotating shaft 72 is connected to the second motor 71. A second arm 73 is connected to the second rotating shaft 72. A pure water nozzle 70 is provided at a tip of the second arm 73. The pure water nozzle 70 supplies pure water onto the substrate W in rinsing processing after the etching processing. When the etching processing is performed using the processing liquid nozzle 50, the pure water nozzle 70 is retracted to a predetermined position.

The rotating shaft 25 to which the spin chuck 21 is fixed is composed of a hollow shaft. A processing liquid supply pipe 26 is inserted through the rotating shaft 25. A processing liquid such as pure water or a chemical liquid serving as an etchant is supplied to the processing liquid supply pipe 26. The processing liquid supply pipe 26 extends to a position in close proximity to a lower surface of the substrate W held in the spin chuck 21. A lower surface nozzle 27 for discharging the processing liquid toward the center on the lower surface of the substrate W is provided at a tip of the processing liquid supply pipe 26.

The spin chuck 21 is accommodated within a processing cup 23. A cylindrical partition wall 33 is provided inside the processing cup 23. A drain space 31 for draining the processing liquid used for the etching processing of the substrate W is formed so as to surround the spin chuck 21. Furthermore, a liquid recovery space 32 for recovering the processing liquid used for the etching processing of the substrate W is formed between the processing cup 23 and the partition wall 33 so as to surround the drain space 31.

A drain pipe 34 for introducing the processing liquid into a drain processing device (not shown) is connected to the drain space 31. A recovery pipe 35 for introducing the processing liquid into a recovery and reuse device, described later, is connected to the liquid recovery space 32.

A guard 23 is provided above the processing cup 24 for preventing the processing liquid from the substrate W from being splashed outward. The guard 24 is shaped to be rotationally-symmetric with respect to the rotating shaft 25. An annular-shaped drain guide groove 41 with a V-shaped cross section is formed inwardly at an upper end of the guard 24.

A liquid recovery guide 42 having an inclined surface that is inclined outwardly downward is formed inwardly at a lower end of the guard 24. A partition wall housing groove 43 for receiving the partition wall 33 inside the processing cup 23 is formed in the vicinity of an upper end of the liquid recovery guide 43. A guard lifting mechanism (not shown) composed of a ball-screw mechanism or the like is connected to the guard 24.

The guard lifting mechanism moves the guard 24 upward and downward between a recovery position in which the liquid recovery guide 42 is opposite to outer edges of the substrate W held on the spin chuck 21 and a drain position in which the drain guide groove 41 is opposite to the outer edges of the substrate W held on the spin chuck 21.

When the guard 24 is in the recovery position (the position of the guard 24 shown in FIG. 1), the processing liquid splashed outward from the substrate W is introduced into the liquid recovery space 32 by the liquid recovery guide 42, and is then recovered through the recovery pipe 35. On the other hand, when the guard 24 is in the drain position, the processing liquid splashed outward from the substrate W is introduced into the drain space 31 by the drain guide groove 41, and is then drained through the drain pipe 34. The foregoing configuration causes the processing liquid to be drained and recovered. When the substrate W is carried onto the spin chuck 21, the guard lifting mechanism further retracts the guard 24 downward from the drain position to move such that an upper end 24a of the guard 24 is at a position lower than the height at which the spin chuck 21 holds the substrate W.

Above the spin chuck 21, a disk-shaped shielding plate 22 having an opening at its center is provided. A supporting shaft 29 extends vertically downward from the vicinity of an end of an arm 28, and the shielding plate 22 is mounted on a lower end of the supporting shaft 29 so as to be opposite to the upper surface of the substrate W held on the spin chuck 21.

A nitrogen gas supply passage 30 that communicates with the opening of the shielding plate 22 is inserted through the supporting shaft 29. Nitrogen gas (N₂) is supplied to the nitrogen gas supply passage 30. The nitrogen gas supply passage 30 supplies the nitrogen gas to the substrate W at the time of drying processing after the rinsing processing with pure water.

A pure water supply pipe 39 that communicates with the opening of the shielding plate 22 is inserted through the nitrogen gas supply passage 30. Pure water or the like is supplied to the pure water supply pipe 39.

A shielding plate lifting mechanism 37 and a shielding plate rotation mechanism 38 are connected to the arm 28. The shielding plate lifting mechanism 37 moves the shielding plate 22 upward and downward between a position in close proximity to the upper surface of the substrate W held on the spin chuck 21 and a position spaced upwardly apart from the spin chuck 21. The shielding plate rotation mechanism 38 rotates the shielding plate 22.

(2) Configuration of Recovery and Reuse Device

The configuration of a recovery and reuse device for reusing the processing liquid recovered through the recovery pipe 35 shown in FIG. 1 will be described while referring to the drawings.

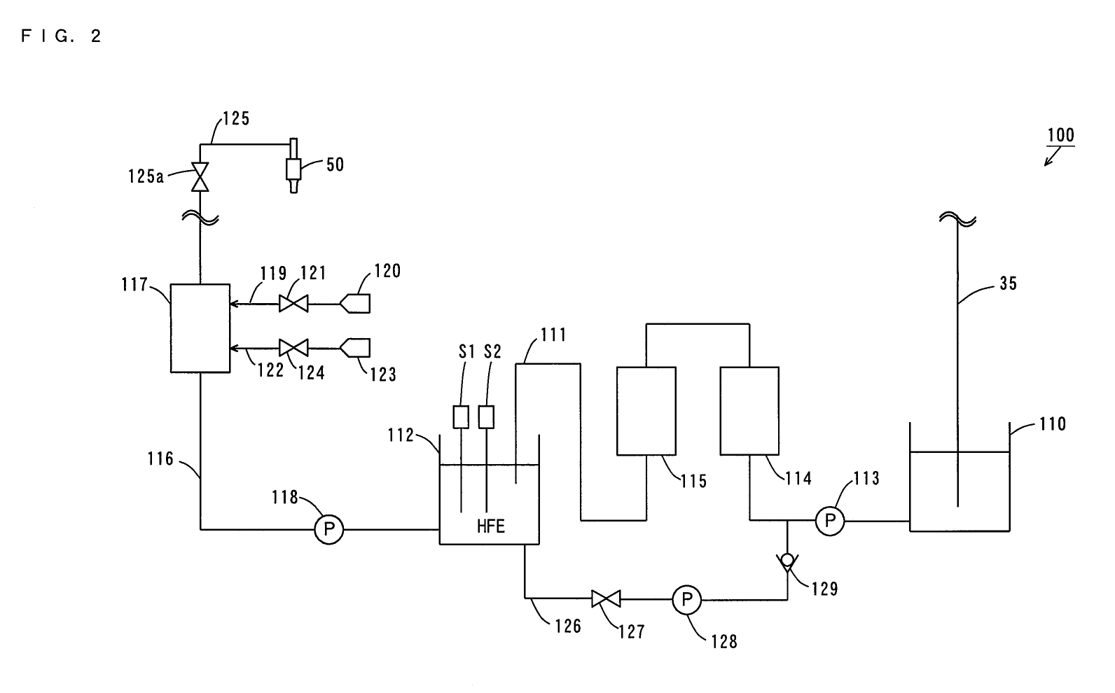

FIG. 2 is a schematic block diagram showing the configuration of the recovery and reuse device 100.

As shown in FIG. 2, the recovery and reuse device 100 comprises a recovery tank 110. The recovery pipe 35 extends into the recovery tank 110. Such a configuration causes the processing liquid to be stored in the recovery tank 110 through the recovery pipe 35.

The recovery tank 110 is connected to a purification tank 112 by a pipe 111. A pump 113, an impurity removal filter 114, and an ion component removal filter 115 are inserted in this order through the pipe 111 in a direction away from the recovery tank 110.

In the present embodiment, in order to etch an oxide film formed on the substrate W, used as the processing liquid supplied to the substrate W by the processing liquid nozzle 50 shown in FIG. 1 is a mixture of a fluorine-based organic solvent and a hydrophilic organic solvent, both being highly volatile, with an acid chemical liquid (e.g., hydrofluoric acid (HF), hydrochloric acid (HCl), sulfuric acid (H₂SO₄), phosphoric acid (H₃PO₄), or the like). The acid chemical liquid is hereinafter referred to as an acid liquid.

The fluorine-based organic solvent is mixed with the acid liquid to improve the precision of the etching processing. However, the fluorine-based organic solvent is not easily mixed with the acid liquid because it is hydrophobic.

Therefore, in the present embodiment, the hydrophilic organic solvent is mixed with the acid liquid and the fluorine-based organic solvent. Thus, the fluorine-based organic solvent is satisfactorily mixed with the acid liquid.

Examples of the fluorine-based organic solvent include hydrofluoroethers (HFEs), hydrofluorocarbons (HFCs), and per-fluoroalkylhaloeters (PFAHEs).

Specific examples of the hydrofluoroethers include CH₃OCF₂CF₃, C₂H₅OCF₂CF₃, C₂F₅C (OCH₃) CF (CF₃)₂, n-C₃F₇OCH₃, (CF₃)₂CFOCH₃, n-C₄F₉OCH₃, (CF₃)₂CFCF₂OCH₃, n-C₃F₇OC₂H₅, n-C₄F₉OC₂H₅, (CF₃)₃COCH₃, (CF₃)₃COC₂H₅, C₄F₉OC₂F₄H, C₆F₁₃OCF₂H, HCH₃F₆OC₃F₆H, C₃F₇OCH₂F, HCF₂OCF₂OCF₂H, HC₂OCF₂CF₂OCF₂H, HC₃F₆OCH₃, and HCF₂OCF₂OC₂F₄OCF₂H.

Specific examples of the hydrofluorocarbons include CF₃CHFCHFCF₂CF₃, CF₃CH₂CF₂H, CF₂HCF₂CH₂F, CH₂FCF₂CFH₂, CF₂HCH₂CF₂H, CF₂HCFHCF₂H, CF₃CFHCF₃, CF₃CH₂CF₃, CHF₂ (CF₂) H, CF₃CF₂CH₂CH₂F, CF₃CH₂CF₃CH₂F, CH₃CHFCF₂CF₃, CF₃CH₂CH₂CF₃, CH₂FCF₂CF₂CH₂F, CF₃CH₂CF₂CH₃, CHF₂CH(CF₃)CF₃, CHF(CF₃)CF₂CF₃, CF₃CH₂CHFCF₂CF₃, CF₃CHFCH₂CF₂CF₃, CF₃CH₂CHFCF₂CF₃, CF₃CHFCH₂CF₂CF₃, CF₃CH₂CF₂CH₂CF₃, CF₃CHFCHFCF₂CF₃, CF₃CH₂CH₂CF₂CF₃, CH₃CHFCF₂CF₂CF₃, CF₃CF₂CF₂CH₂CH₃, CH₃CF₂CF₂CF₂CF₃, CF₃CH₂CHFCH₂CF₃, CH₂FCF₂CF₂CF₂CF₃, CHF₂CF₂CF₂CF₂CF₃, CH₃CF(CHFCHF₂)CF₃, CH₃CH (CF₂CF₃)CF₃, CHF₂CH(CHF₂)CF₂CF₃, CHF₂CF(CHF₂)CF₂CF₃, CHF₂CF₂CF(CHF₂)CF₂CF₃, CHF₂CF(CHF₂)CF₂CF₃, CHF₂CF₂CF(CF₃)₂, CHF₂(CF₂)₄CF₂H, (CF₃CH₂)₂CHCF₃, CH₃CHFCF₂CHFCHFCF₃, HCF₂CHFCF₂CF₂CHFCF₂H, H₂CFCF₂CF₂CF₂CF₂CF₂H, CHF₂CF₂CF₂CF₂CF₂CHF₂, CH₃CF(CF₂H)CHFCHFCF₃, CH₃CF(CF₃)CHFCHFCF₃, CH₃CF(CF₃)CF₂CF₂CF₃, CHF₂CF₂CH(CF₃)CF₂CF₃, CHF₂CF₂CF(CF₃)CF₂CF₃, CH₃CHFCH₂CF₂CHFCF₂CF₃, CH₃(CF₂)₅CH₃, CH₃CH₂(CF₂)CF₄CF₃, CF₃CH₂CH₂(CF₂)₃CF₃, CH₂FCF₂CHF(CF₂)₃CF₃, CF₃CF₂CF₂CHFCHFCF₂CF₃, CF₃CF₂CF₂CHFCFCHFCF₂CF₃, CF₃CF₂CF₂CHFCF₂CF₂CF₃, CH₃CH(CF₃)CF₂CF₂CF₂CH₃, CH₃CF(CF₃)CH₂CFHCF₂CF₃, CH₃CF(CF₂CF₃)CHFCF₂CF₃, CH₃CH₂CH(CF₃)CF₂CF₂CF₃, CHF₂CF(CF₃)(CF₂)₃CH₂F, CH₃CF₂C(CF₃)₂CF₂CH₃, CHF₂CF(CF₃)(CF₂)₃CF₃, CH₃CH₂CH₂CH₂CF₂CF₂CF₂CF₂CF₃, CH₃ (CF₂)₆CH₃, CHF₂CF(CF₃)(CF₂)₄CHF₂, CHF₂CF(CF₃)(CF₂)₄CHF₂, CH₃CH₂CH(CF₃)CF₂CF₂CF₂CF₃, CH₃CF(CF₂CF₃)CHFCF₂CF₂CF₃, CH₃CH₂CH₂CHFC(CF₃)₂CF₃, CH₃C(CF₃)₂CF₂CF₂CF₂CH₃, CH₃CH₂CH₂CF(CF₃)CF(CF₃)₂, and CH₂FCF₂CF₂CHF(CF₂)₃CF₃.

Furthermore, specific examples of the per-fluoroalkylhaloeters include c-C₆F₁₁-OCH₂Cl, (CF₃)₂CFOCHCl₂, (CF₃)₂CFOCH₂Cl, CF₃CF₂CF₂OCH₂Cl, CF₃CF₂CF₂OCHCl₂, (CF₃)₂CFCF₂OCHCl₂, (CF₃)₂CFCF₂OCH₂Cl, CF₃CF₂CF₂CF₂OCH₂Cl, (CF₃)₂CFCF₂OHClCH₃, CF₃CF₂CF₂CF₂OCHClCH₃, (CF₃)₂CFCF(C₂F₅) OCH₂Cl, (CF₃)₂CFCF₂OCH₂Br, and CF₃CF₂CF₂OCH₂I. In the present embodiment, used as the fluorine-based organic solvent are hydrofluoroethers (hereinafter simply referred to as HFEs).

The HFEs have a boiling point lower than those of pure water and IPA (isopropyl alcohol) generally used for cleaning processing, have a specific gravity (density) higher than that of IPA, and have surface tension lower than that of IPA. The solubility of the HFEs in pure water is higher than that of IPA.

Examples of the hydrophilic organic solvent include alcohols and ketones (e.g., acetone).

The processing liquid stored in the recovery tank 110 is stored in the purification tank 112 after passing through the impurity removal filter 114 and the ion component removal filter 115 via the pipe 111 by a suction operation of the pump 113. In the impurity removal filter 114, impurities (e.g., water, an etching residue, particles, or the like) included in the processing liquid are removed.

In the ion component removal filter 115, an ion component (mainly anions) in the processing liquid including an acid liquid, HFEs, and a hydrophilic organic solvent is removed.

In the present embodiment, the ion component removal filter 115 removes fluorine ions (F⁻) when hydrofluoric acid (HF) is used as the acid liquid, while removing chlorine ions (Cl⁻) when hydrochloric acid (HCl) is used as the acid liquid.

Similarly, the ion component removal filter 115 removes sulfate ions (SO₄²⁻) when sulfuric acid (H₂SO₄) is used as the acid liquid, while removing phosphate ions (PO₄³⁻) when phosphoric acid (H₃PO₄) is used as the acid liquid.

In this case, hydrogen ions (H⁺) are released as hydrogen molecules (H₂). Thus, the acid liquid is removed from the processing liquid.

The ion component removal filter 115 also removes water, a hydrophilic organic solvent, metal ions, or the like included in the processing liquid.

In such a way, the acid liquid, the hydrophilic organic solvent, and the impurities are removed from the processing liquid.

Here, in the present embodiment, a filter composed of alumina, for example, can be employed as the ion component removal filter 115. Alumina is white crystal powder obtained by burning aluminum hydroxide Alumina (α-alumina) obtained by burning aluminum hydroxide at a high temperature is chemically stable, has a high melting point, and has high mechanical strength and insulation resistance, and has high hardness. Alumina can be used as an adsorbent capable of removing the ion component included in the processing liquid because it has a hydroxyl group (—OH) and has a pore distribution like activated carbon. The ion component removal filter 115 in this example is a container packed with granular sintered alumina spheres obtained by sintering the crystal powder.

Then, the processing liquid from which the ion component has been removed by the ion component removal filter 115 is stored within the purification tank 112 through the pipe 111. The processing liquid from which the ion component has been removed by the ion component removal filter 115 is hereinafter referred to as a post-removal processing liquid.

Provided in the purification tank 112 is a concentration sensor S1 for measuring the concentration of anions (e.g., fluorine ions (F⁻), chlorine ions (Cl⁻), sulfate ions (SO₄²⁻) or phosphate ions (PO₄³⁻) remaining in the post-removal processing liquid within the purification tank 112. Further provided in the purification tank 112 is a concentration sensor S2 for measuring the concentration of a hydrophilic organic solvent (e.g., alcohols or ketones) remaining in the post-removal processing liquid within the purification tank 112.

The purification tank 112 is connected to one liquid inlet of a mixing valve 117 by the pipe 116. A pump 118 is inserted through the pipe 116. By such a configuration, the post-removal processing liquid stored within the purification tank 112 is fed into the mixing valve 117 through the pipe 116 by a suction operation of the pump 118.

An acid liquid supply source 120 and a hydrophilic organic solvent supply source 123 are respectively connected to the other two liquid inlets of the mixing valve 117 through a pipe 119 and a pipe 122. A valve 121 is inserted through the pipe 119, and a valve 124 is inserted through the pipe 122.

The acid liquid supply source 120 supplies an acid liquid (hydrofluoric acid (HF), hydrochloric acid (HCl), sulfuric acid (H₂SO₄), phosphoric acid (H₃PO₄), or the like), and the hydrophilic organic solvent supply source 123 supplies a hydrophilic organic solvent (alcohols or ketones).

In such a configuration, the acid liquid from the acid liquid supply source 120 is supplied to the mixing valve 117 through the pipe 119 and the valve 121 depending on the results of the measurement made by the concentration sensor S1. In the mixing valve 117, the post-removal processing liquid and the supplied acid liquid are mixed with each other.

The hydrophilic organic solvent from the hydrophilic organic solvent supply source 123 is supplied to the mixing valve 117 through the pipe 122 and the valve 124 depending on the results of the measurement made by the concentration sensor S2. In the mixing valve 117, the post-removal processing liquid and the supplied hydrophilic organic solvent are mixed with each other.

A liquid outlet of the mixing valve 117 is connected to the processing liquid nozzle 50 shown in FIG. 1 through a pipe 125. In the mixing valve 117, a processing liquid (hereinafter referred to as a new processing liquid) produced by mixing one or both of the acid liquid and the hydrophilic organic solvent with the post-removal processing liquid is supplied to the processing liquid nozzle 50 shown in FIG. 1 through the pipe 125 and a valve 125a inserted through the pipe 125. Thus, the processing liquid nozzle 50 supplies the new processing liquid onto the substrate W.

Here, one end of a pipe 126 is connected to the purification tank 112. The other end of the pipe 126 is connected to a portion of the pipe 111 between the pump 113 and the impurity removal filter 114. A pump 128 and a backflow preventing valve 129 are inserted through the pipe 126.

When the concentration of the anions measured by the concentration sensor S1 or the concentration of the hydrophilic organic solvent measured by the concentration sensor S2 respectively exceed predetermined threshold values, a valve 127 is opened. Thus, the post-removal processing liquid within the purification tank 112 is fed into the pipe 111 through the pipe 126 and the backflow preventing valve 129 by a suction operation of the pump 128.

The post-removal processing liquid fed into the pipe 111 is fed into the purification tank 112 after the impurity removal filter 114 and the ion component removal filter 115 remove at least one of the impurities and the ion component. The above-mentioned processing is repeated until the concentration of the anions measured by the concentration sensor S1 and the concentration of the hydrophilic organic solvent measured by the concentration sensor S2 respectively reach not more than the above-mentioned predetermined threshold values. This allows the purity of the fluorine-based organic solvent in the post-removal processing liquid to be increased.

The new processing liquid recovered and reused by the recovery and reuse device 100 may be drained outward by a pipe and a drain device (which are not shown) after processing in lots of the substrates W is terminated, for example.

(3) Control System of Substrate Processing Apparatus

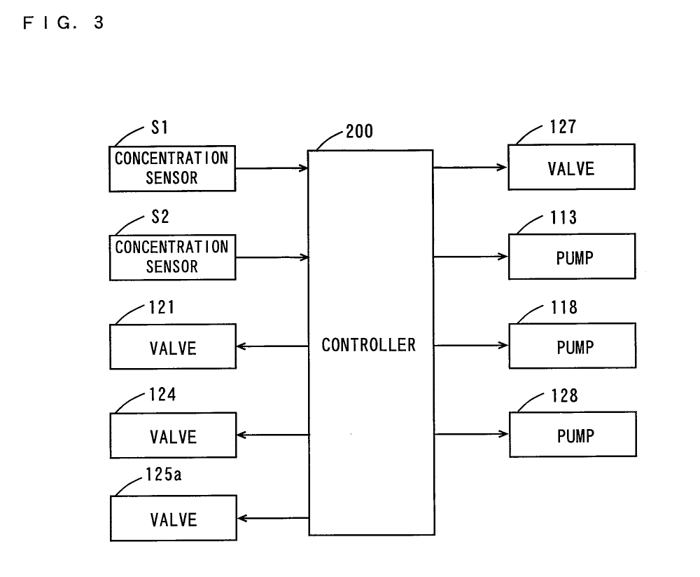

FIG. 3 is a block diagram showing the configuration of a control system of the substrate processing apparatus MP.

In FIG. 3, a controller 200 comprises a CPU (Central Processing Unit), a memory, and so on. The controller 200 controls the pumps 113, 118, and 128 and the valves 121, 124, 125a, and 127 on the basis of the processing steps of the substrate processing apparatus MP shown in FIG. 1 and the results of the measurements made by the concentration sensors S1 and S2. This allows the substrate processing apparatus MP to perform processing while recovering and reusing the fluorine-based organic solvent in the processing liquid.

(4) Effects of the Present Embodiment

In the present embodiment, the acid liquid can be thus removed from the processing liquid by removing the anions of the acid liquid in the processing liquid, so that the post-removal processing liquid including the fluorine-based organic solvent can be obtained. Furthermore, a processing liquid having a desired concentration and components can be reproduced by mixing the acid liquid with the post-removal processing liquid. In such a way, a high-cost fluorine-based organic solvent can be reused. This allows the processing cost to be reduced.

Since the impurity removal filter 114 removes the impurities included in the processing liquid that has already been used, the purity of the fluorine-based organic solvent included in the post-removal processing liquid can be increased. Furthermore, since the post-removal processing liquid is returned to the upstream of the impurity removal filter 114 on the basis of the results of the measurements made by the concentration sensors S1 and S2, the purity of the fluorine-based organic solvent included in the post-removal processing liquid can be further increased. This allows a new processing liquid having high purity to be produced in the mixing valve 117.

In the present embodiment, the mixing valve 117 mixes at least one of the acid liquid and the hydrophilic organic solvent in a desired amount with the fluorine-based organic solvent. Consequently, the ratio of components in the processing liquid to be supplied onto the substrate W by the processing liquid nozzle 50 can be adjusted. This allows a processing liquid corresponding to the type of film formed on the substrate W, processing conditions, and so on to be supplied.

(5) Another Embodiment

Although in the above-mentioned embodiment, the pure water nozzle 70 for supplying pure water onto the substrate W is provided, the present invention is not limited to the same. The pure water nozzle 70 need not be provided, provided that the following is carried out.

That is, valves 121 and 124 are closed so that an acid liquid and a hydrophilic organic solvent are not mixed with a fluorine-based organic solvent serving as a post-removal processing liquid in a mixing valve 117. This allows the fluorine-based organic solvent to be supplied onto a substrate W from a processing liquid nozzle 50 at the time of rinsing processing. Thus, the substrate W is cleaned using a highly volatile fluorine-based organic solvent at the time of rinsing processing, to improve drying properties as well as eliminate the necessity of providing a pure water nozzle 70. This allows space saving of a substrate processing apparatus MP.

Although in the above-mentioned embodiment, an impurity removal filter 114 and an ion component removal filter 115 are provided in a series manner in a pipe 111, the present invention is not limited to the same. For example, they may be provided in a parallel manner, and they may be respectively provided with valves. In this case, the post-removal processing liquid can be selectively returned to one or both of the impurity removal filter 114 and the ion component removal filter 115 by a pump 128. This allows impurities, an acid liquid, and a hydrophilic organic solvent to be efficiently removed.

Furthermore, although in the above-mentioned embodiment, the ion component removal filter 115 composed of alumina is used for removing the ion component, the hydrophilic organic solvent, or the like in the processing liquid, the present invention is not limited to the same. For example, the ion component can be recovered and removed using an ion exchanger or the like.

(6) Correspondence Between Elements in the Claims and Parts in Embodiments

In the following paragraphs, non-limiting examples of correspondences between various elements recited in the claims below and those described above with respect to various embodiments of the present invention are explained.

In the embodiments described above, the processing liquid nozzle 50 is an example of a supplier, the guard 24, the liquid recovery space 32, the recovery pipe 35, and the liquid recovery guide 42 are an example of a recovery system, the ion component removal filter 115 is an example of an ion remover, the mixing valve 117 is an example of a mixer, and the pipe 125 and the valve 125a are an example of a first circulating system.

Furthermore, in the embodiments described above, the impurity removal filter 114 is an example of an impurity remover, the purification tank 112 is an example of a storage, the concentration sensor S1 or the concentration sensor S2 is an example of a concentration detector, and the pipe 126, the valve 127, and the pump 128 are an example of a second circulating system.

As each of various elements recited in the claims, various other elements having configurations or functions described in the claims can be also used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A substrate processing apparatus for processing a substrate, comprising:
a supplier that supplies to the substrate a processing liquid including a fluorine-based organic solvent and an acid liquid;
a recovery system that recovers the processing liquid supplied to the substrate by said supplier;
an ion remover that removes anions of the acid liquid in the processing liquid recovered by said recovery system, to obtain the post-removal processing liquid from which said anions have been removed;
a mixer that mixes the acid liquid with the post-removal processing liquid obtained by said ion remover, to reproduce the processing liquid; and
a first circulating system that returns to said supplier the processing liquid reproduced by said mixer.

2. The substrate processing apparatus according to claim 1, wherein
said fluorine-based organic solvent includes at least one type of hydrofluoroethers, hydrofluorocarbons, and per-fluoroalkylhaloeters.

3. The substrate processing apparatus according to claim 1, wherein
said ion remover includes a filter composed of alumina.

4. The substrate processing apparatus according to claim 1, further comprising
an impurity remover that removes impurities included in the processing liquid recovered by said recovery system.

5. The substrate processing apparatus according to claim 1, further comprising
a storage that stores the post-removal processing liquid obtained by said ion remover.

6. The substrate processing apparatus according to claim 5, further comprising
a concentration detector that detects the concentration of at least one type of components in the post-removal processing liquid stored in said storage,
said mixer mixing the acid liquid with the post-removal processing liquid on the basis of the results of the detection by said concentration detector.

7. The substrate processing apparatus according to claim 6, further comprising
a second circulating system that returns the post-removal processing liquid stored in said storage to the upstream of said ion remover on the basis of the results of the detection by said concentration detector.

8. The substrate processing apparatus according to claim 1, wherein
said acid liquid includes at least one type of hydrofluoric acid, hydrochloric acid, sulfuric acid, and phosphoric acid.

9. The substrate processing apparatus according to claim 1, wherein
the processing liquid supplied to the substrate by said supplier further includes a hydrophilic organic solvent,
said ion remover further removes the hydrophilic organic solvent in the processing liquid recovered by said recovery system, and
the mixer further mixes the hydrophilic organic solvent with the post-removal processing liquid obtained by said ion remover.

10. The substrate processing apparatus according to claim 9, wherein
said hydrophilic organic solvent includes at least one type of alcohols and ketones.

11. The substrate processing apparatus according to claim 1, wherein
said supplier supplies the processing liquid to the substrate and then supplies to the substrate the post-removal processing liquid with which the acid liquid has not been mixed by said mixer.
